(19) United States
(12) Patent Application Publication
(10) Pub. No.: US 2005/0230577 A1
(43) Pub. Date: Oct. 20, 2005

(54) Hanger for use on metal rack

(76) Inventor: Henry Chen, Taipei (TW)

Correspondence Address: LAW OFFICE OF LIAUH & ASSOCIATES;SUITE 5-388, 4224 WAIALAE AVENUE, HONOLULU, HI, 96816-5307, US

(21) Appl. No.: 10/828,710

(22) Filed: Apr. 19, 2004

(51) Int. Cl. B42F 1/00

(52) U.S. Cl. 248/215; 248/304

(57) ABSTRACT

A hanger for use on metal rack is integrally injection molded and includes a hook portion provided at an upper end thereof, at least one engaging recess located below and behind the hook portion, and a supporting seat provided at a lower free end of the hanger. The hanger is firmly connected to a metal rack by directly hooking the hook portion to an upper horizontal metal bar at a vertical front of the metal rack with the engaging recess engaged with a lower horizontal metal bar at the vertical front of the metal rack. A crossbar may be supported at two ends in the supporting seats of two hangers connected to the metal rack for holding suit hangers thereto.

### FIELD OF THE INVENTION

The present invention relates to a hanger for use on metal rack, and more particularly to a hanger that can be directly hooked to a vertical front of a metal rack.

### BACKGROUND OF THE INVENTION

A metal rack is frequently fixed to a wall surface for holding things, so that valuable space in a room could be fully utilized without the need of spending a lot of money for a custom-made cabinet or closet. The metal rack may be covered with curtains or drapes to define a closed storage space and serves as, for example, a cabinet, a closet, or a wardrobe. When the metal rack is used as a wardrobe, it is desirable a crossbar may be fixed below the metal rack for holding some suit hangers.

FIG. 1 shows a conventional metal rack 10 that includes a vertically downward bent front to increase the structural strength of the metal rack 10, preventing the metal rack 10 from easy deformation. An upper and a lower horizontal metal bar 11, 12 are welded to an upper and a lower end, respectively, of the vertical front of the metal rack 10, such that a plurality of metal wires 13 forming the metal rack 10 are extended between the two horizontal metal bars 11, 12. FIG. 2 is an exploded perspective view of a conventional hanger 14 for use on the metal rack 10. The hanger 14 includes a box 15 provided at an upper end thereof, and a supporting seat 16 connected to a lower free end thereof for supporting a crossbar 17 thereon (see FIG. 1). The box 15 includes an openable cover 18. Two lateral sidewalls of the box 15 are symmetrically provided with upper and lower recesses 151, 152 for the upper and the lower horizontal metal bars 11, 12 of the metal rack 10 to engage therewith before the cover 18 is closed to the box 15 with a screw and thereby locks the closed box 15 to the metal bars 11, 12 and connects the hanger 14 to the metal rack 10. The box 15 of the hanger 14 occupies a large volume and has complicate structure that necessitates relatively high manufacturing cost and causes inconveniences in connecting the hanger 14 to the metal rack 10.

It is therefore tried by the inventor to develop an improved hanger for use on metal rack to eliminate drawbacks existed in the conventional hanger, including the inconvenience of screwing the conventional hanger to the metal rack, and the high manufacturing cost resulted from the complicate hanger structure.

### SUMMARY OF THE INVENTION

A primary object of the present invention is to provide a hanger that could be directly hooked to a vertical front of a metal rack and is therefore more convenient for use.

Another object of the present invention is to provide a hanger for use on metal rack that can be easily integrally injection molded at reduced cost to be more competitive in the market.

To achieve the above and other objects, the hanger for use on metal rack according to the present invention includes a hook portion provided at an upper end thereof, at least one engaging recess located below and behind the hook portion, and a supporting seat provided at a lower free end of the hanger. The hanger is firmly connected to a metal rack by hooking the hook portion to an upper horizontal metal bar at a vertical front of the metal rack with the engaging recess engaged with a lower horizontal metal bar at the vertical front of the metal rack.

The supporting seat defines an upper opening and a curved seat, allowing a crossbar to force into the curved seat via the upper opening.

In the hanger of the present invention, it is preferable the hook portion is faced toward the vertical front of the metal rack and the engaging recess toward the wall surface onto which the metal rack is mounted.

In the hanger of the present invention, the hook portion is provided along a profile thereof with a substantially vertically extended slit to cut the hook portion into two lateral halves. The hanger is connected to the metal rack with the slit aligned with one metal wire at the vertical front of the metal rack, so that the hanger is restrained from moving laterally on the metal rack.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing the use of a conventional hanger on a metal rack;

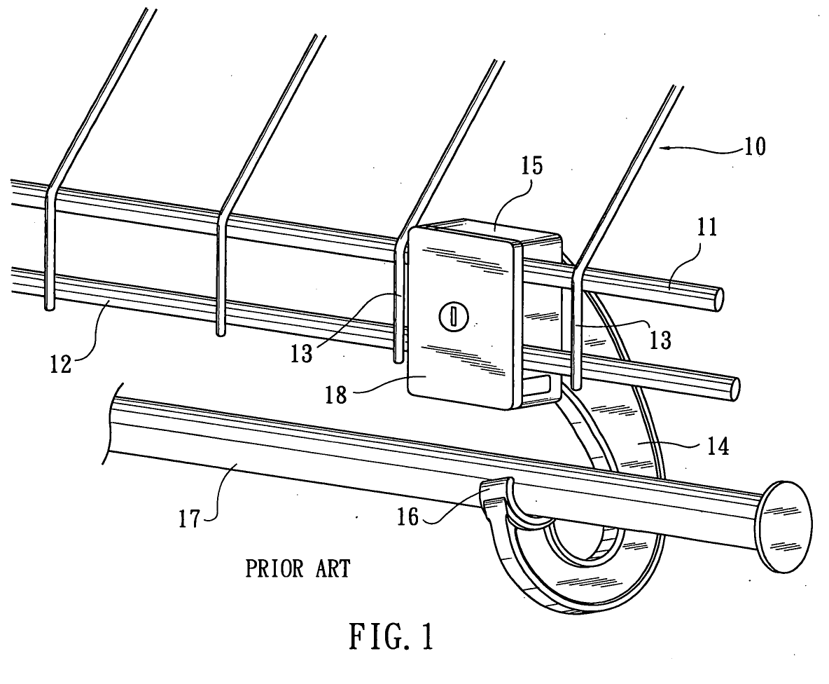

FIG. 2 is an exploded perspective view of the conventional hanger of FIG. 1;

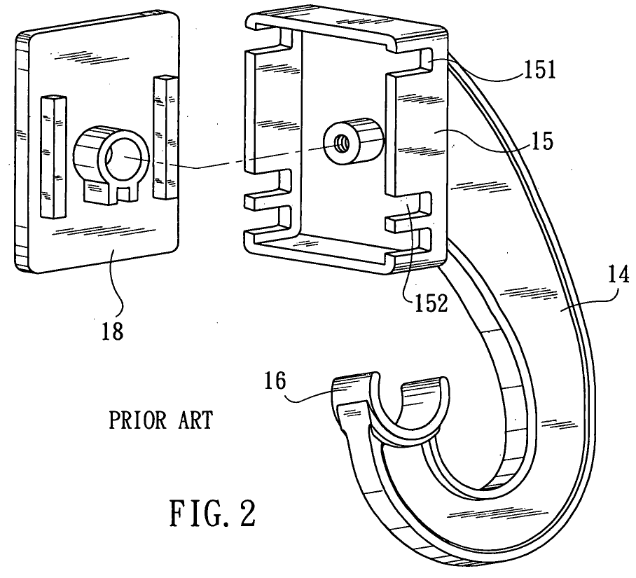

FIG. 3 is a perspective view of a hanger for use on metal rack according to the present invention;

FIG. 4 is a top perspective view showing the connection of the hanger of the present invention to a metal rack;

FIG. 5 is a side view of FIG. 4;

FIG. 6 shows two hangers of the present invention in use before a crossbar is connected thereto; and

FIG. 7 is similar to FIG. 6 with the crossbar connected to the hangers.

### DETAILED DESCRIPTION OF THE PREFERRED EMBODIMENTS

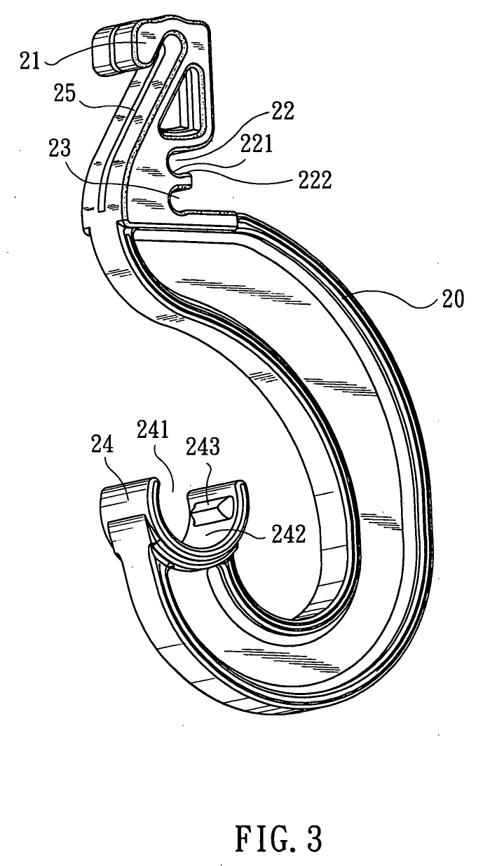

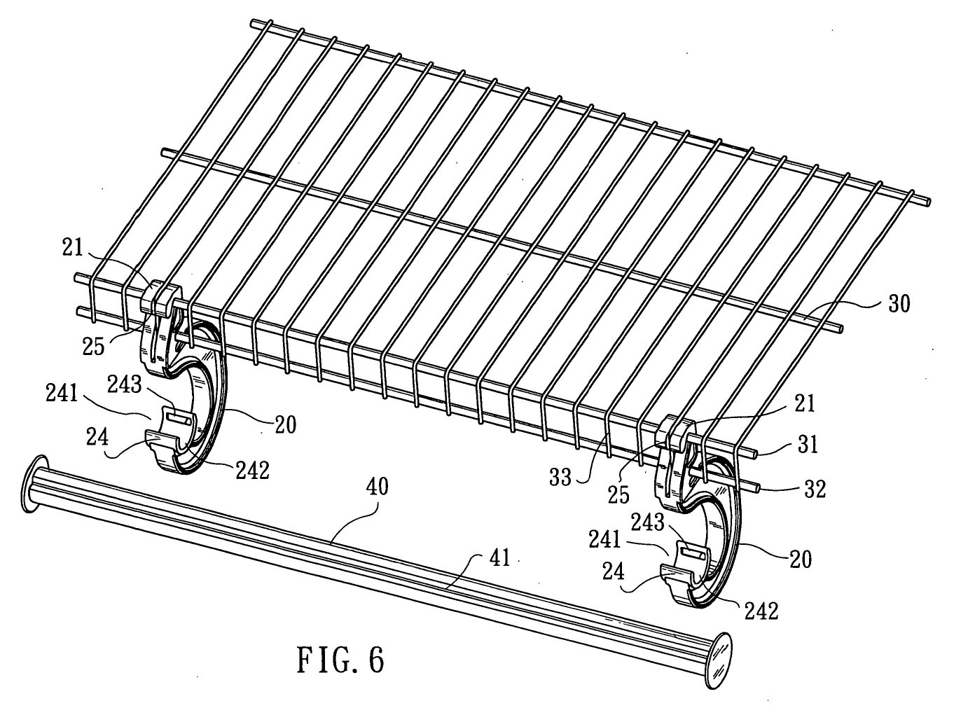

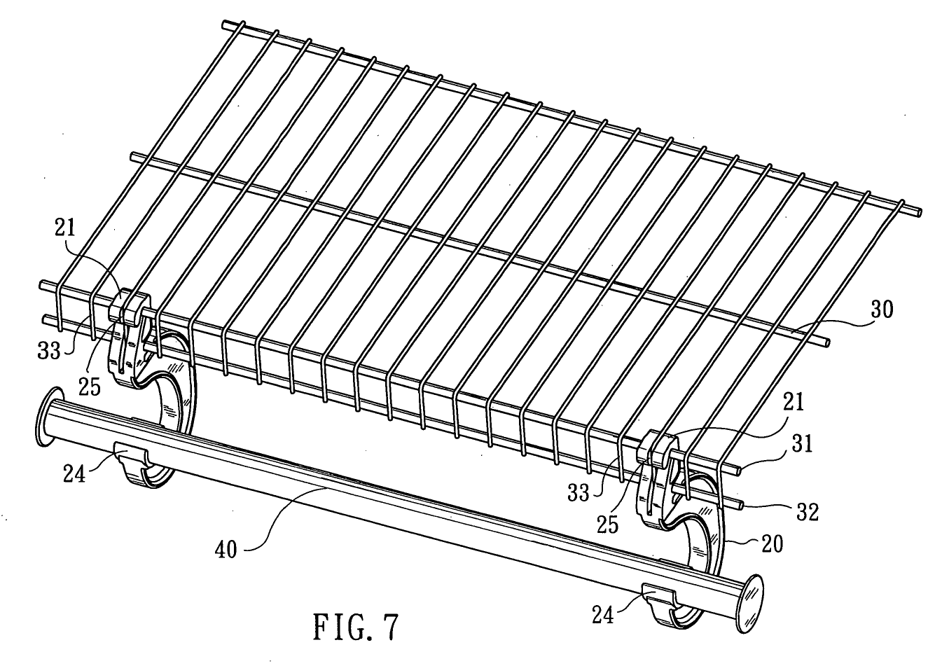

Please refer to FIG. 3 that is a perspective view of a hanger 20 according to the present invention for use on a metal rack 30 as shown in FIG. 6. The metal rack 30 is fixed to a wall surface using fastening means (not shown), such that a top of the metal rack 30 is in a horizontal position. As can be seen from FIGS. 6 and 7, a predetermined length of a front end of the metal rack 30 is downward bent by 90 degrees to form a vertical front, and an upper and a lower horizontal metal bars 31, 32 are transversely welded to upper and lower end, respectively, of the vertical front to intersect with a plurality of metal wires 33 forming the metal rack 30.

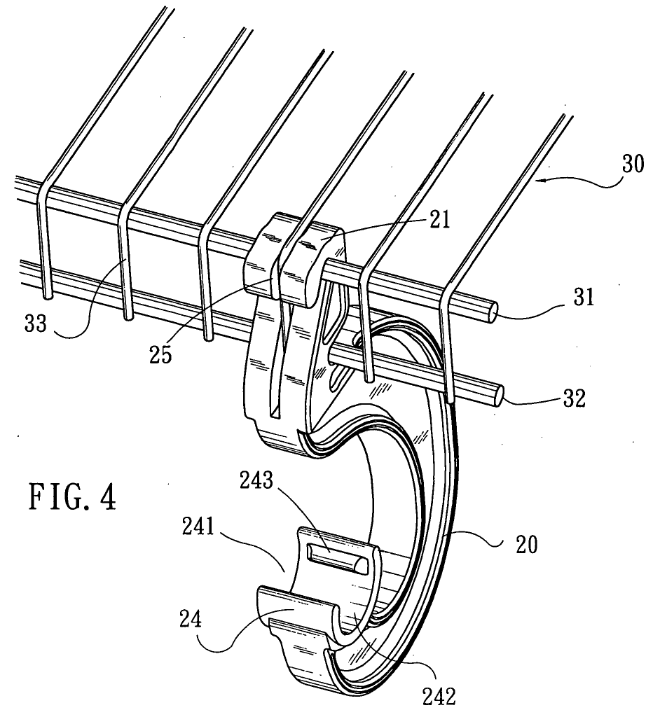

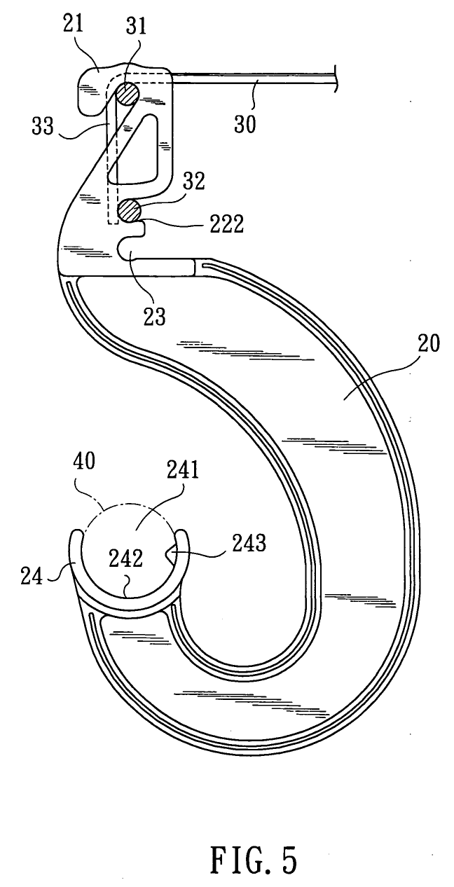

Please refer to FIGS. 3, 4, and 5 at the same time. The hanger 20 is provided at an upper end with an open-bottomed hook portion 21, at a position closely below and behind the hook portion 21 with at least one horizontal engaging recess 22, 23, and at a lower free end with a supporting seat 24. An inner top of the hook portion 21 is located right above an inner end of the engaging recess 22, 23. The hanger 20 is connected to the metal rack 30 by hooking the hook portion 21 to the upper horizontal metal bar 31 with the engaging recess 22 or 23 engaged with the lower horizontal metal bar 32. A distance from the inner top of the hook portion 21 to an inner lower end 221 of the engaging recess 22 is slightly smaller than a distance from an upper side of the upper horizontal metal bar 31 to a lower side of the lower horizontal metal bar 32, so as to ensure absolutely firm connection of the hanger 20 to the metal rack 30. Moreover, the inner lower end 221 of the engaging recess 22 is slightly lower than an outer lower end 222 of the engaging recess 22, so that the lower horizontal metal bar 32 passing the outer lower end 222 into the engaging recess 22 is firmly seated in the inner lower end 221 of the engaging recess 22 without the risk of easily moving out of the engaging recess 22.

A height difference between the hook portion 21 and the engaging recess 22 depends on a height difference between the upper and the lower horizontal metal bars 31, 32. The currently commercially available metal racks 30 provide two types of height difference between the upper and the lower horizontal metal bars 31, 32. Therefore, two horizontally parallelly arranged engaging recesses 22, 23 are provided on the hanger 20 of the present invention to correspond to the two types of height difference between the upper and the lower horizontal metal bars 31, 32, so that the hanger 20 may be used with either type of the currently commercially available metal racks 30.

Please refer to FIGS. 6 and 7. The supporting seat 24 on the hanger 20 is open-topped to define an upper opening 241 and a curved seat 242. It is possible to stably support a crossbar 40 on two hangers 20 by downward forcing two ends of the crossbar 40 into the curved seats 242 via the upper openings 241 of the two hangers 20. The crossbar 40 supported on the hangers 20 may therefore be used to hold other suit hangers (not shown). The curved seat 242 may be provided on an inner wall close to the upper opening 241 with a horizontal rib 243, and the crossbar 40 may be provided with an axially extended groove 41 corresponding to the rib 243, so that the rib 243 engages with the groove 41 to firmly hold the crossbar 40 to the supporting seat 24, preventing the crossbar 40 from easily separating from the hanger 20 via the upper opening 241.

The hanger 20 is provided along a profile of the hook portion 21 with a substantially vertically extended slit 25 to cut the hook portion 21 into two lateral halves. An upper end of the slit 25 is located at a front end of the hook portion 21 and a lower end of the slit 25 is located at a height the same as that of a lower side of the engaging recess 23. Therefore, the hanger 20 may be connected to the upper and the lower horizontal bars 31, 32 of the metal rack 30 with the slit 25 aligned and engaged with one of the metal wires 33 located at the vertical front of the metal rack 30. The hanger 20 may then be fully connected to the metal rack 30 in the same manner as previously described. With the vertical metal wire 33 located in the slit 25, the hanger 20 is restrained from moving laterally on the metal rack 30.

It is preferable a phase difference of 180 degrees exists between an orientation of the hook portion 21 of the hanger 20 and an orientation of the engaging recesses 22, 23. That is, when an opening of the hook portion 21 of the hanger 20 is faced toward a front side of the metal rack 30, openings of the engaging recesses 22, 23 are preferably faced toward the wall surface onto which the metal rack 30 is mounted.

To connect the hanger 20 to the metal rack 30, first hook the hook portion 21 to the upper horizontal metal bar 31 with the opening of the hook portion 21 facing away from the wall surface, and downward turn the hanger 20 about the metal bar 31 to forcedly engage one suitable engaging recess 22 or 23 with the lower horizontal metal bar 32 at the vertical front of the metal rack 30. The hanger 20 is now firmly held to the front of the metal rack 30.

The hanger 20 may be integrally formed with a plastic material through injection molding, and can therefore be easily manufactured at reduced cost to be more competitive in the market. The hanger 20 can be easily operated to quickly and conveniently connect to the metal rack 30, and therefore meets most general consumers' requirements. The integrally formed hanger 20 also provides better structural strength and durability. The slit 25 at the upper hook portion 21 of the hanger 20 also enables the hanger 20 to be more stably connected to the metal rack 30.

1. A hanger for use on a metal rack, said hanger comprising a hook portion located at an upper end of said hanger, at least one engaging recess located closely below and behind said hook portion, so that an inner top of said hook portion is located right above an inner end of said engaging recess, and a supporting seat located at a lower free end of said hanger; said supporting seat defining an upper opening and a curved seat, such that a crossbar may be forced into said curved seat via said upper opening;
wherein said curved seat on said supporting seat is provided on an inner wall close to said upper opening with a horizontal rib, and said crossbar to be supported in said curved seat is provided with an axial groove corresponding to said horizontal rib for engaging with said rib.

2. The hanger for use on metal rack as claimed in claim 1, wherein a distance from the inner top of said hook portion to an inner lower end of said at least one engaging recess is slightly smaller than a distance from an upper side of said upper horizontal metal bar to a lower side of said lower horizontal metal bar at said vertical front of said metal rack.

3. The hanger for use on metal rack as claimed in claim 2, wherein said inner lower end of said at least one engaging recess is slightly lower than an outer lower end of the same said engaging recess.

4. (canceled)

5. A hanger for use on a metal rack, said hanger comprising a hook portion located at an upper end of said hanger, at least one engaging recess located closely below and behind said hook portion, so that an inner top of said hook portion is located right above an inner end of said engaging recess, and a supporting seat located at a lower free end of said hanger; said supporting seat defining an upper opening and a curved seat, such that a crossbar may be forced into said curved seat via said upper opening; wherein said hook portion is provided along a profile thereof with a substantially vertically extended slit to cut said hook portion into two lateral halves, an upper end of said slit being located at a front end of said hook portion, and a lower end of said slit being located at a height the same as that of a lower side of said engaging recess.

6. The hanger for use on metal rack as claimed in claim 1, wherein a phase difference of 180 degrees exists between an orientation of said hook portion and an orientation of an opening of said engaging recess.
